(19) United States
(12) Patent Application Publication
(10) Pub. No.: US 2025/0373934 A1
(43) Pub. Date: Dec. 4, 2025

(54) DETERMINING A TEMPERATURE OF AN OBJECT VIA A MOBILE DEVICE

(71) Applicant: Google LLC, Mountain View, CA (US)

(72) Inventor: Kuan-Lin Chen, Palo Alto, CA (US)

(21) Appl. No.: 18/676,709

(22) Filed: May 29, 2024

(51) Int. Cl. H04N 23/60; G01J 5/10; G06T 7/11; G06T 7/174; H04N 23/61

(52) U.S. Cl. CPC H04N 23/64; G01J 5/10; G06T 7/11; G06T 7/174; H04N 23/61; G06T 2200/24; G06T 2207/30242

(57) ABSTRACT

A system and related method for determining a temperature of an object via a mobile device having a camera that generates image data across a first field of view, and a temperature sensor that generates temperature data across a second field of view overlapping the first field of view. A computing system receives the image data, each of the plurality of images of the image data being associated with a different respective position of the mobile device. The computing system also receives the temperature data, each of the plurality of average temperatures of the temperature data corresponding to a respective one of the plurality of images. The computing system determines, based at least in part on the plurality of images and the plurality of average temperatures, a temperature of a desired object at least partially within the first and second fields of view.

### FIELD

The present disclosure relates generally to mobile computing devices and, more particularly, to systems and methods for using a temperature sensor and an image sensor of a mobile computing device to determine a temperature of an object.

### BACKGROUND

Generally, mobile computing devices (e.g., smartphones, smart watches, Augmented Reality (AR)/Virtual Reality (VR) devices, laptops, etc.) include a variety of sensors to determine the state of the environment surrounding the computing device. For example, some mobile computing devices, such as smartphones, include one or more temperature (e.g., infrared) sensors to generate data indicative of the temperature of objects within the field of view of the temperature sensor(s). However, depending on the angle range of the field of view of such temperature sensor(s), the temperature sensor(s) may need to be held very close to an object to avoid surrounding objects from affecting the accuracy of the temperature of the object determined from the data generated by the temperature sensor(s).

Accordingly, systems and methods for accurately determining the temperature of an object with a temperature sensor of the wearable device that overcomes such issue would be welcomed in the art.

### SUMMARY OF THE INVENTION

Aspects and advantages of embodiments of the disclosure will be set forth in part in the following description, or can be learned from the description, or can be learned through practice of the example embodiments.

In one aspect, a system for determining a temperature of an object is provided. The system may include a mobile device, the mobile device having a camera configured to generate image data across a first field of view, and a temperature sensor configured to generate temperature data across a second field of view, where the first field of view and the second field of view at least partially overlap. The system may additionally include a computing system, where the computing system may be configured to receive the image data generated by the camera, where the image data may be indicative of a plurality of images, and where each of the plurality of images may be associated with a different respective position of the mobile device such that the first field of view in each of the plurality of images only partially spatially overlaps the first field of view in each other image of the plurality of images. The computing system may further be configured to receive the temperature data generated by the temperature sensor, where the temperature data may be indicative of a plurality of average temperatures, and where each of the plurality of average temperatures may correspond to a respective one of the plurality of images. Additionally, the computing system may determine, based at least in part on the plurality of images and the plurality of average temperatures, a temperature of a desired object, where the desired object is at least partially within both the first field of view and the second field of view during generation of the image data and the temperature data.

In another aspect, a method for determining a temperature of an object is provided. The method may include receiving, with a computing system, image data generated by a camera of a mobile device, where the camera has a first field of view, and where the image data may be indicative of a plurality of images, with each of the plurality of images being associated with a different respective position of the mobile device such that the first field of view in each of the plurality of images only partially spatially overlaps the first field of view in each other image of the plurality of images. The method may further include receiving, with the computing system, temperature data generated by a temperature sensor of the mobile device, where the temperature sensor has a second field of view, with the first field of view and the second field of view at least partially overlapping, and where the temperature data may be indicative of a plurality of average temperatures, with each of the plurality of average temperatures corresponding to a respective one of the plurality of images. Moreover, the method may include determining, with the computing system, a temperature of a desired object based at least in part on the plurality of images and the plurality of average temperatures, with the desired object being at least partially within both the first field of view and the second field of view during generation of the image data and the temperature data. Additionally, the method may include controlling, with the computing system, a user interface to provide the temperature of the desired object.

These and other features, aspects, and advantages of various embodiments of the disclosure will become better understood with reference to the following description, drawings, and appended claims. The accompanying drawings, which are incorporated in and constitute a part of this specification, illustrate examples of the disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a front view of an example mobile computing device according to example embodiments of the present disclosure;

FIG. 2 depicts a rear view of an example mobile computing device according to example embodiments of the present disclosure;

FIG. 3 illustrates a schematic view of a system for determining a temperature of an object using a mobile computing device in accordance with aspects of the present subject matter;

FIGS. 4A-4C each illustrate a different position of a field of view of a camera and an associated overlapping field of view of a temperature sensor of a mobile computing device with respect to a target object to be detected in accordance with aspects of the present subject matter;

FIG. 5 illustrates a field of view of an example temperature sensor of a mobile computing device suitable for determining a temperature of an object in accordance with aspects of the present subject matter;

FIG. 6 illustrates an example graph of energy detected by the temperature sensor shown in FIG. 5 in accordance with aspects of the present subject matter;

FIGS. 7A-7B illustrate example flow diagrams for guiding a user to collect data for determining a temperature of an object using a mobile computing device in accordance with aspects of the present subject matter; and

FIG. 8 illustrates an example method for determining a temperature of an object using a mobile computing device in accordance with aspects of the present subject matter.

Repeat use of reference characters in the present specification and drawings is intended to represent the same and/or analogous features or elements of the present invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations may be made to the embodiments without departing from the scope or spirit of the present disclosure. For instance, features illustrated or described as part of one embodiment may be used with another embodiment to yield a still further embodiment. Thus, it is intended that aspects of the present disclosure cover such modifications and variations. Furthermore, it should be understood that the drawings are intended to represent structures for purposes of identification and description and are not intended to represent the structures to physical scale.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (e.g., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” do not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

Relative terms such as “below” or “above” or “upper” or “lower” or “horizontal” or “lateral” or “vertical” may be used herein to describe a relationship of one element, layer or region to another element, layer or region as illustrated in the figures. It will be understood that these terms are intended to encompass different orientations of the device in addition to the orientation depicted in the figures. Furthermore, unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

In the drawings and specification, there have been disclosed typical embodiments and, although specific terms are employed, they are used in a generic and descriptive sense only and not for purposes of limitation of the scope set forth in the following claims. Furthermore, like numbers refer to like elements throughout. Thus, the same or similar numbers may be described with reference to other drawings even if they are neither mentioned nor described in the corresponding drawing. Also, elements that are not denoted by reference numbers may be described with reference to other drawings.

In general, the present subject matter is related to systems and methods for determining the temperature of an object via a mobile computing device, particularly using a temperature sensor and a separate image sensor (e.g., camera) of a mobile computing device. When the field of view of a temperature sensor (e.g., infrared sensor) of a mobile computing device (e.g., smartphone) is configured as a single-pixel temperature sensor, the data output from such temperature sensor only indicates an average of the temperatures detected across the entire field of view of the temperature sensor. Currently, there is no way to isolate the temperature readings within the field of view for just the intended object when the intended object does not cover the entire field of view of the infrared sensor. As such, the temperature output for a target or desired object within the field of view is affected by the temperatures of any other object within the field of view. Thus, the temperature currently detected for a target object using such a single-pixel temperature sensor is not accurate unless the target object covers the entire field of view of the temperature sensor. This is made more difficult when the field of view of the temperature sensor is wide, as the target object must be very close to the temperature sensor to cover the entire field of view.

To overcome such issue, data is simultaneously taken with both the temperature sensor and a separate image sensor (e.g., camera) of a mobile computing device (e.g., smartphone), where the field of view of the temperature sensor and the field of view of the camera at least partially overlap, and where the mobile computing device is far enough away from a target object that the field of view of the temperature sensor and the field of view of the camera can include more than the target object (e.g., the target object and surrounding room, another object, and/or the like). The field of view of the temperature sensor is overlaid onto the corresponding image from the camera, and the respective portion of the overlapping area corresponding to the target object and each other object is determined (e.g., using image analysis techniques). In some embodiments, the amount of infrared energy detected at different areas within the field of view of the temperature sensor varies. For instance, the amount of infrared energy detected closer to the center of the field of view of the temperature sensor is, in some embodiments, greater than the amount of infrared energy detected closer to the outside of the field of view of the temperature sensor. As such, the portion of the overlapping area corresponding to the target object and the portion of the overlapping area corresponding to each other object are weighted according to the location within the field of view of the temperature sensor for each image, then the corresponding temperature data for each image is evaluated using linear analysis (e.g., linear algebra or regression techniques). As such, the temperature of the target object may be isolated from the temperature of surrounding objects without requiring the temperature sensor to be very close to the target object, which reduces user error and increases accuracy of the temperature detection.

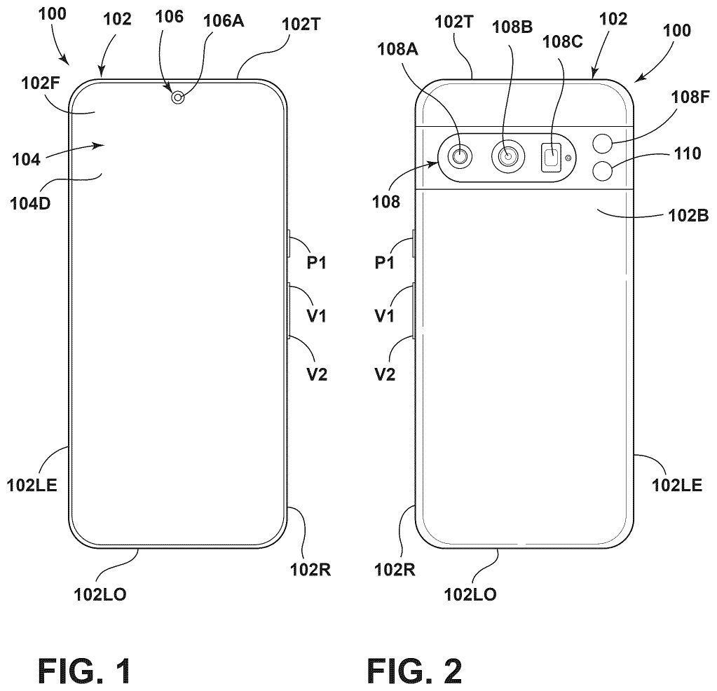

Referring now to the figures, FIGS. 1 and 2 depict an example mobile computing device according to example embodiments of the present disclosure. More particularly, FIG. 1 depicts a front view of the example mobile computing device and FIG. 2 depicts a rear view of the example mobile computing device. It should be understood that FIGS. 1-2 depict the example mobile computing device and its various components for purposes of illustration and discussion. Those having ordinary skill in the art, using the disclosures provided herein, will appreciate that example aspects of the present disclosure may be implemented by any suitable mobile computing device, such as, by way of non-limiting example, a mobile tablet device, a wearable computing device, and the like.

As shown in FIGS. 1 and 2, the mobile computing device 100 is configured as a smartphone device. The mobile computing device 100 may include a housing 102. The housing 102 may include any suitable material, such as aluminum, titanium, plastic, and/or the like. The housing 102 may generally define a back surface 102B (e.g., back side), a top surface 102T (e.g., top side), a bottom surface 102LO (e.g., bottom side), and one or more side surfaces (e.g., left side 102LE, right side 102R, etc.) of the mobile computing device 100. The housing 102 may further define a cavity (e.g., internal volume) (not shown) in which one or more electronic components (e.g., disposed on printed circuit boards) are disposed. For instance, the mobile computing device 100 may include one or more printed circuit boards (e.g., flexible printed circuit board) (not shown) disposed within the cavity on which one or more electronic components are supported. The mobile computing device 100 may further include a battery (not shown) that is disposed within the cavity defined by the housing. Furthermore, the mobile computing device 100 may also include one or more temperature sensors (not shown) within the cavity that are configured to obtain internal temperature data indicative of an internal temperature within the cavity of the mobile computing device 100.

As particularly shown in FIG. 1, the mobile computing device 100 may include a display assembly 104. The display assembly 104 may define a front surface 102F (e.g., front side) of the mobile computing device 100. The display assembly 104 may be configured to display content (e.g., time, date, biometric, notifications, etc.) for viewing by a user and to receive inputs from a user. Furthermore, as discussed below, the display assembly 104 may be a touch-sensitive display assembly that is sensitive to the touch of a user object (e.g., finger, stylus, and the like). The touch-sensitive display assembly may serve to implement, for instance, a virtual keyboard.

More particularly, in some examples, the display assembly 104 may include a display 104D. The display 104D may include a plurality of pixels. For instance, in some examples, the display 104D may include an organic light-emitting diode (OLED) display. It should be understood, however, that the display 104D may include any suitable display without deviating from the scope of the present disclosure. In some examples, the display 104D may be configured an “always-on” display operable to display content to the user in a quickly accessible way (e.g., “At a Glance”). In particular, in some examples, content is displayed on the display 104D even when the user is not explicitly interacting with the computing device 100. In this manner, users may quickly access information by viewing content and performing actions without needing to invoke the computing device 100 (e.g., performing “wake up” functions to activate the computing device 100).

The display assembly 104 may further include a display cover (not shown in detail) positioned on the housing 102 such that the display cover is positioned on top of the display 104D. In this manner, the display cover may protect the display 104D from being damaged (e.g., scratched or cracked). In some examples, the display assembly 104 may include a seal positioned between the housing 102 and the display cover. For instance, a first surface of the seal may contact the housing 102 and a second surface of the seal may contact the display cover. In this manner, the seal between the housing 102 and the display cover may prevent a liquid (e.g., water) from entering the cavity defined by the housing 102. It should be understood that the display cover may be optically transparent so that the user may view information being displayed on the display 104D. For instance, in some examples, the display cover may include a glass material. It should be understood, however, that the display cover may include any suitable optically transparent material.

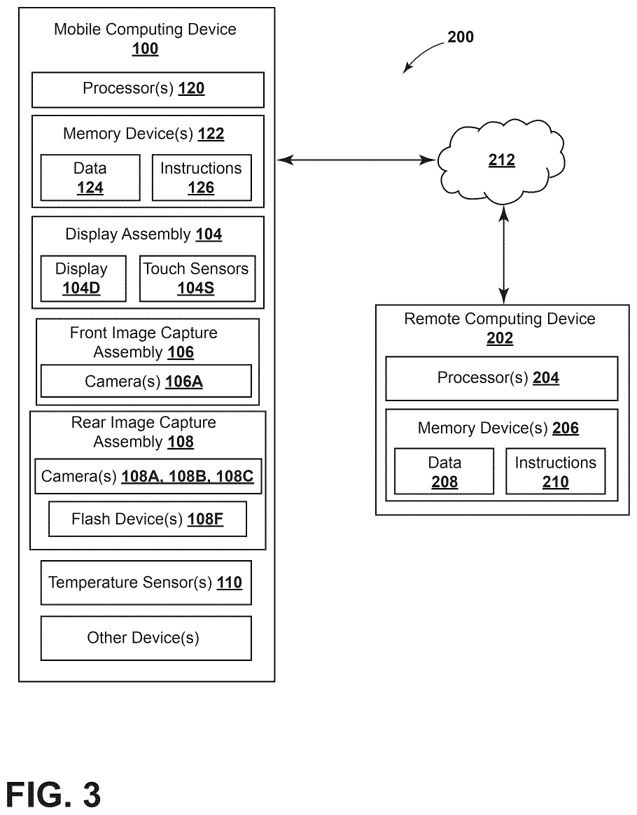

The display assembly 104 may further include one or more touch sensors 104S (FIG. 3) operable to detect one or more inputs (e.g., touch inputs) provided by the user touching the display assembly 104 (e.g., display cover). In this manner, the display assembly 104 may be a touch-sensitive display assembly. In some examples, one or more of the touch sensors 104S may include a capacitive sensor whose capacitance changes when a touch input is provided at a location on the display cover that corresponds to the capacitive sensor. It should be understood, however, that the touch sensors 104S may include any suitable type of sensor configured to detect a touch input provided by the user touching the display cover.

As further shown in FIGS. 1 and 2, the mobile computing device 100 may include one or more image capture assemblies. For instance, as shown in FIG. 1, the mobile computing device 100 may include a front image capture assembly 106 on/within the front surface 102F of the mobile computing device. The front image capture assembly 106 may include, for instance, one or more front-facing cameras 106A operable to capture images and/or videos. In some examples, the front image capture assembly 106 may be operable to implement a variety of image capture-related tasks, such as autofocus of an aperture and/or lens and the like. It should be understood that the front image capture assembly 106 may include any suitable image capture device without deviating from the scope of the present disclosure.

As shown in FIG. 2, the mobile computing device 100 may further include a rear image capture assembly 108 on the rear/back surface 102B of the mobile computing device 100. In some examples, the rear image capture assembly 108 may include a plurality of image capture devices (e.g., lens assembly) operable to capture images and/or videos. For instance, in some examples, the rear image capture assembly 108 may include a wide camera 108A, an ultrawide camera 108B, and a telephoto camera 108C. The rear image capture assembly 108 may also include one or more flash devices 108F, such as an LED flash. In some examples, the rear image capture assembly 108 may be operable to implement a variety of image capture-related tasks, such as auto focus of an aperture and/or lens, lens correction, zoom, optical and/or electronic image stabilization, and the like. By way of non-limiting example, as described below, the rear image capture assembly 108 may include a laser detect auto-focus (LDAF) system operable to automatically focus one or more apertures/lenses for the mobile computing device 100.

It should be appreciated that the mobile computing device 100 may include (and receive data from) any other suitable devices. For instance, the mobile computing device 100 may further include one or more LIDAR sensors, one or more audio sensors (e.g., microphone(s)), one or more inertial sensors (e.g., inertial measurement unit(s) (IMU(s))), one or more biometric sensors (e.g., heart rate sensor(s), pulse sensor(s), retinal sensor(s), fingerprint sensor(s), etc.), one or more optical sensors, one or more location sensors (e.g., GPS), one or more temperature sensors, and/or the like. For instance, as will be described in greater detail below, in accordance with aspects of the present subject matter, the mobile computing device 100 further includes one or more temperature sensors 110 for generating temperature data indicative of one or more objects external to the mobile computing device 100. In one instance, at least one of the temperature sensor(s) 110 is configured as an infrared (IR) sensor. In particular embodiments, the temperature sensor(s) 110 is configured as a single-pixel temperature sensor, where the temperature data output from the temperature sensor(s) 110 only indicates an average of the temperatures detected across an entire field of view of the temperature sensor. An example temperature sensor suitable for use as the temperature sensor(s) 110 is a single-pixel infrared sensor, such as the Melexis MLX90632 Infrared Temperature Sensor. In some instances, one or more of the temperature sensor(s) 110 is positioned on the back side 102B of the mobile computing device 100.

The mobile computing device 100 may further include one or more buttons and/or ports. For instance, in some examples, the mobile computing device 100 may include a power port (not shown) for connecting the battery to an external charging source. The mobile computing device 100 may also include one or more volume buttons V1, V2 operable to control a volume of audio output by one or more speakers. The mobile computing device may also include a power button P1 operable to control a power state (e.g., “ON,” “OFF,” “IDLE,” “STANDBY,” etc.) of the mobile computing device. It should be understood that the mobile computing device 100 may include any other suitable buttons, ports, or combinations thereof without deviating from the scope of the present disclosure.

The mobile computing device 100 may be operable to communicate with remote computing systems and devices and/or third-party computing systems and devices over a variety of telecommunications networks. For instance, the mobile computing device 100 may include a Subscriber Identity Module (SIM) card, which, in conjunction with one or more antennas (e.g., mmWave antenna), allows the mobile computing device 100 to communicate over one or more telecommunications networks, such as a cellular network and the like. The mobile computing device 100 may also be operable to connect to wireless networks, such as local area networks, Wi-Fi networks, and the like. Even further, the mobile computing device 100 may include Near Field Communication (NFC) components operable to provide NFC capabilities to the mobile computing device.

In some examples, the mobile computing device 100 may include one or more output devices. For instance, as noted above, the one or more output devices may include the display 104D. The one or more output devices may further include one or more speakers. In this manner, the mobile computing device 100 may emit audible noises (e.g., alarm, voice automated messages, audio, etc.) for the user. The one or more output devices may further include one or more haptic devices operable to provide one or more haptic notifications (e.g., vibratory notifications) to the user. It should be appreciated that the mobile computing device 100 may include any suitable output device without deviating from the scope of the present disclosure.

Referring now to FIG. 3, a schematic view of a system 200 for determining a temperature of an object is illustrated in accordance with aspects of the present subject matter. The system 200 includes a mobile computing device, such as the mobile computing device 100 described above. As described above with reference to FIGS. 1 and 2, the mobile computing device 100 may constitute and/or include a mobile phone. However, it should be appreciated that the mobile computing device 100 may be any other suitable device or combinations of devices, such as a wearable computing device, a mobile tablet device, a laptop, a VR device, an AR device, and/or the like. The mobile computing device 100 has the display assembly 104, including the display 104D and the touch sensors 104S. The mobile computing device 100 further includes the front image capture assembly 106 having the front camera(s) 106A. The mobile computing device 100 further includes the rear image capture assembly 108 having the rear camera(s) 108A, 108B, 108C and the flash device(s) 108F. Moreover, the mobile computing device 100 includes the temperature sensor(s) 110. As will be described in greater detail below, a field of view of at least one image capture device (e.g., camera(s) 108A, 108B, 108C) and a field of view of at least one temperature sensor (e.g., temperature sensor(s) 110) of the mobile computing device 100 at least partially overlap. Additionally, the mobile computing device 100 includes any other suitable device(s), such as microphone(s), speaker(s), haptic device(s), LDAF system, LIDAR sensor(s), inertial sensor(s), biometric sensor(s), optical sensor(s), location sensor(s), and/or the like.

Moreover, as shown in FIG. 3, the mobile computing device 100 further includes control circuitry. Although certain modules and/or components are illustrated as part of control circuitry in the diagram of FIG. 3, it should be understood that control circuitry associated with mobile computing device 100 and/or other components or devices of the system 200 in accordance with example embodiments of the present disclosure can include additional components and/or circuitry such as, for instance, one or more additional components of the illustrated components depicted in FIG. 3. Furthermore, in certain embodiments, one or more of the illustrated components of control circuitry can be omitted and/or different than that shown in FIG. 3 and described in association therewith.

The term “control circuitry” is used herein according to its broad and/ordinary meaning and can include any combination of software and/or hardware elements, devices, and/or features that can be implemented in connection with operation of mobile computing device 100. Furthermore, the term “control circuitry” can be used substantially interchangeably in certain contexts herein with one or more of the terms “controller,” “integrated circuit,” “IC,” “application-specific integrated circuit,” “ASIC,” “controller chip,” or the like.

Control circuitry according to example embodiments of the present disclosure can constitute and/or include one or more processors, data storage devices, and/or electrical connections. In one embodiment, control circuitry can be implemented on a system on a chip (SoC), however, those skilled in the art will recognize that other hardware and/or firmware implementations are possible.

In the illustrated embodiment, the control circuitry of the mobile computing device 100 constitutes and/or includes one or more processors 120 and one or more memory devices 122. The one or more processors 120 may include any suitable processing device (e.g., a processor core, a microprocessor, an application specific integrated circuit (AISC), a field programmable gate array (FPGA), a microcontroller, etc.). In some examples, the one or more processors 120 may be communicatively coupled to the other components of the mobile computing device 100 (e.g., the display assembly 104, the front image capture assembly 106, the rear image capture assembly 108, the temperature sensor(s) 110, and any other device(s)). For instance, the processor(s) 120 may be communicatively coupled to the other component(s) of the mobile computing device 100 via a data interface (e.g., one or more data buses). In this manner, the processor(s) 120 may obtain data from and/or control the other component(s) of the mobile computing device 100. The memory device(s) 122 may include one or more non-transitory computer-readable storage media, such as random-access memory (RAM), read-only memory (ROM), electronically erasable programmable read-only memory (EEPROM), erasable programmable read-only memory (EPROM), flash memory devices, and combinations thereof. The memory device(s) 122 may store data 124 and instructions 126 that, when executed by the processor(s) 120, cause the mobile computing device 100 to perform one or more operations, such as any of the operations disclosed herein.

In some instances, the computing system 200 may further include a remote computing system 202. The remote computing system 202 may, similar to the mobile computing device 100, include one or more processors 204 and one or more memory devices 206. Similar to the processor(s) 120 of the mobile computing device 100, the processor(s) 204 of the remote computing system 202 may be any suitable processing device (e.g., a processor core, a microprocessor, an ASIC, an FPGA, a controller, a microcontroller, etc.) and may be one processor or a plurality of processors that are operatively connected. Similar to the memory device(s) 122, the memory device(s) 206 of the remote computing system 202 may include one or more non-transitory computer-readable storage medium(s), such as RAM, ROM, EEPROM, EPROM, flash memory devices, magnetic disks, etc., and combinations thereof. The memory device(s) 206 may store data 208 and instructions 210, where the instructions 210, when executed by the processor(s) 204, cause the remote computing system 202 to perform operations, such as any of the operations described herein. In this manner, the remote computing system 202 may be operable to implement any of the methods described herein.

In some examples, the remote computing system 202 may include or may otherwise be implemented by one or more computing devices. In instances in which the remote computing system 202 includes plural server computing devices, such server computing devices may operate according to sequential computing architectures, parallel computing architectures, or some combination thereof.

The mobile computing device 100 may be communicatively coupled to the remote computing system 202 over a network 212. As noted above, the network 212 may be any type of communications network, such as a local area network (e.g., intranet), wide area network (e.g., Internet), or some combination thereof and may include any number of wired or wireless links. In general, communication over the network 212 may be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

Furthermore, the computing system 200 may include or have access to one or more machine-learned models. For instance, the machine-learned models may be or may otherwise include various machine-learned models such as neural networks (e.g., deep neural networks) or other types of machine-learned models, including non-linear models and/or linear models. Neural networks may include feed-forward neural networks, recurrent neural networks (e.g., long short-term memory recurrent neural networks), convolutional neural networks or other forms of neural networks.

In some examples, the one or more machine-learned models may be received from the server computing system 202 over the network 212, stored in the mobile computing device memory 122, and then used or otherwise implemented by the one or more processors 120. In some examples, the mobile computing device 100 may implement multiple parallel instances of a single machine-learned model (e.g., to perform parallel machine-learned model processing across multiple instances of input data and/or detected features).

More particularly, the one or more machine-learned models may include one or more detection models, one or more classification models, one or more segmentation models, one or more augmentation models, one or more generative models, one or more natural language processing models, one or more optical character recognition models, and/or one or more other machine-learned models. The one or more machine-learned models may include one or more transformer models. The one or more machine-learned models may include one or more neural radiance field models, one or more diffusion models, and/or one or more autoregressive language models.

The one or more machine-learned models may be utilized to detect one or more object features. The detected object features may be classified and/or embedded. The classification and/or the embedding may then be utilized to perform a search to determine one or more search results. Alternatively, or additionally, the one or more detected features may be utilized to determine an indicator (e.g., a user interface element that indicates a detected feature) is to be provided to indicate a feature has been detected. The user may then select the indicator to cause a feature classification, embedding, and/or search to be performed. In some implementations, the classification, the embedding, and/or the searching may be performed before the indicator is selected.

In some examples, the one or more machine-learned models may process image data, text data, audio data, and/or latent encoding data to generate output data that may include image data, text data, audio data, and/or latent encoding data. The one or more machine-learned models may perform optical character recognition, natural language processing, image classification, object classification, text classification, audio classification, context determination, action prediction, image correction, image augmentation, text augmentation, sentiment analysis, object detection, error detection, inpainting, video stabilization, audio correction, audio augmentation, and/or data segmentation (e.g., mask based segmentation).

Additionally, or alternatively, one or more machine-learned models may be included in or otherwise stored and implemented by the server computing system 202 that communicates with the mobile computing device 100 according to a client-server relationship. For instance, the machine-learned models may be implemented by the server computing system 202 as a portion of a web service (e.g., a viewfinder service, a visual search service, an image processing service, an ambient computing service, and/or an overlay application service). Thus, one or more models may be stored and implemented at the mobile computing device 100 and/or one or more models may be stored and implemented at the server computing system 202.

The technology discussed herein refers to sensors and other computer-based systems, as well as actions taken, and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

In accordance with aspects of the present subject matter, the computing system 200 may particularly be configured to carry out a temperature sensing application for isolating the temperature of a target object from one or more other objects within the field of view of the temperature sensor(s) 110 of the mobile computing device 100. For instance, as indicated above, a field of view FOV1 of the temperature sensor(s) 110 at least partially overlaps a field of view FOV2 of at least one of the cameras (e.g., camera 108A) of the mobile computing device 100. The computing system 200 may be configured to guide a user through taking a plurality of images with one of the cameras of the mobile computing device 100, where the field of view FOV2 associated with each of plurality of images only partially spatially overlaps the field of view FOV2 associated with each of the other images of the plurality of images, while simultaneously generating temperature data with the temperature sensor(s) 110 of the mobile computing device 100. The temperature of an object within the overlapping field of views FOV1, FOV2 across the multiple images may then be determined.

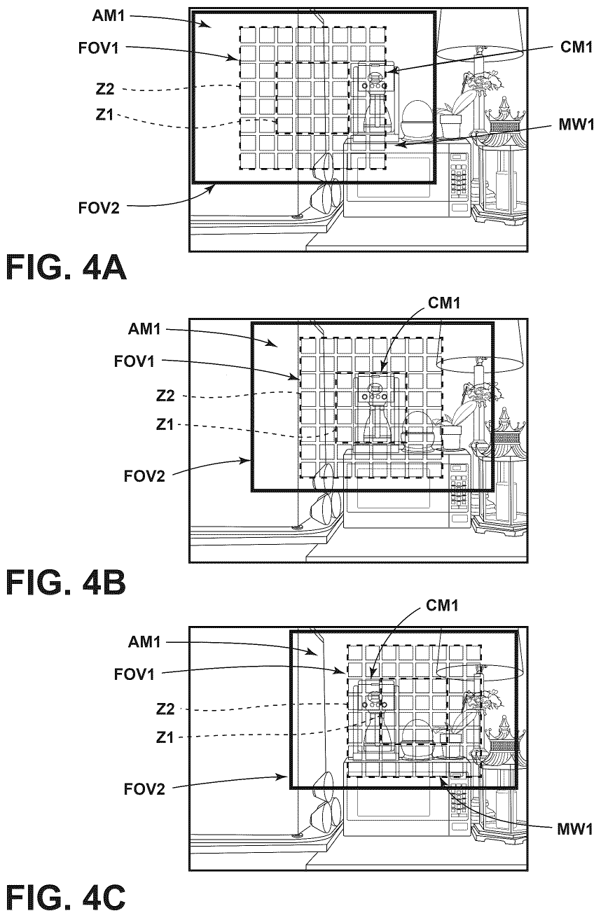

For instance, three different images associated with different spatial positions of the field of view FOV2 of the imaging device within an area of interest AOI are represented in FIGS. 4A-4C, where the field of view FOV2 of the imaging device in each image only partially, spatially overlaps the field of view FOV2 of the imaging device in each other image relative to the area of interest AOI, and where a single object does not take up the entire field of view FOV2 of the imaging device. In some instances, the computing system 200 relies upon image recognition techniques in an initial image(s) to determine the minimum number of images that are necessary to accurately determine the temperature of a target object. For instance, if the computing system 200 identifies four distinct objects within the field of view FOV2 of the imaging device for the initial image(s), the computing system 200 may determine that at least four images taken by the imaging device with corresponding temperature data generated by the temperature sensor are necessary to properly determine the temperature of the four distinct objects (or at least a target or desired object of the four distinct objects). In some instances, the computing system 200 displays or otherwise provides the initial image(s) generated from the imaging device(s) (e.g., camera(s) 108A, 108B, 108C) to a user (e.g., via display 104D) and allows a user to select a desired object within the initial image(s) to determine the temperature of using the mobile computing device 100, such as, for example, using touch features of the display assembly 104. In some instances, the computing system 200 may identify objects (e.g., create a drop down list, highlight objects, etc.) from the initial image(s) which the user may select the desired object, or the user may identify the object (e.g., circle the object(s) within the initial image(s)). After the desired object(s) are selected by the user, the computing system 200 may then determine the minimum number of images and corresponding temperatures needed to accurately determine the temperature(s) of the desired object(s). It should be appreciated that more than the minimum number of images with corresponding temperature data may be taken.

For each of the plurality of images, the computing system 200 may determine an overlapping region where the field of view FOV1 of the temperature sensor(s) 110 of the mobile computing device 100 overlaps the field of view FOV2 of the imaging device of the mobile computing device 100. For instance, as shown in FIGS. 4A-4C, the field of view FOV1 of the temperature sensor(s) 110 is shown overlaid onto the field of view FOV2 and represents the overlap region. In some instances, the field of view FOV1 of the temperature sensor(s) 110 is fixed relative to the field of view FOV2 of the imaging device(s). For example, for each zoom setting of the field of view FOV2 of the imaging device(s), the relative size and/or location of overlap of the field of view FOV1 of the temperature sensor(s) 110 may be known. In some instances, the zoom level of the temperature sensor(s) 110 may be static. However, in instances where the zoom level of the temperature sensor(s) 110 is adjustable, the computing system 200 may also take into account the zoom level of the field of view FOV1 of the temperature sensor(s) 110 when determining the overlap of the positioning of the field of view FOV1 of the temperature sensor(s) 110 relative to the field of view FOV2 of the imaging device(s).

The computing system 200 may then identify, for each of the plurality of images, at least one object within the overlap region, where the at least one object includes the target or desired object and at least one other object aside from the desired object. In some instances, the computing system 200 may particularly identify objects that are present in the overlap regions across multiple images. For example, in FIGS. 4A-4C, the target or desired object may be a coffee maker CM1, another object within the overlap region may be a microwave MW1, and a further object may be identified simply as surrounding room or ambient area AM1.

The computing system 200 may then determine, for each respective object of the at least one object, a respective portion of the overlap region that includes the respective object. In some instances, the computing system 200 may first divide the overlap region into discrete elements (e.g., a grid with grid blocks), then determine the respective number of discrete elements of the overlap region for each identified object to determine the respective portion of the overlap region for each respective object. The field of view FOV1 may be circular, rectangular, or any other suitable shape when viewed along the 0° angle. For instance, in the example shown in FIGS. 4A-4C, the field of view FOV1 may be generalized as a square and the overlap region (field of view FOV1) is evenly divided into an eight-by-eight grid. In FIG. 4A, for example, the coffee maker CM1 takes up eight of the sixty-four grid blocks or 12.5% of the overlap region, the microwave MW1 takes up four of the sixty-four grid blocks or 6.25% of the overlap region, and the remaining ambient area AM1 takes up fifty-two of the sixty-four grid blocks or 81.25% of the overlap region. In FIG. 4B, the coffee maker CM1 takes up eight of the sixty-four grid blocks or 12.5% of the overlap region, the microwave MW1 takes up ten of the sixty-four grid blocks or 15.63% of the overlap region, and the remaining ambient area AM1 takes up forty-six of the sixty-four grid blocks or 71.87% of the overlap region. Additionally, in FIG. 4C, coffee maker CM1 takes up eight of the sixty-four grid blocks or 12.5% of the overlap region, the microwave MW1 takes up twelve of the sixty-four grid blocks or 18.75% of the overlap region, and the remaining ambient area AM1 takes up forty-four of the sixty-four grid blocks or 68.75% of the overlap region. The computing system 200 is then configured to determine the temperature of at least one object within the overlap region based at least in part on the respective portion of the overlap region for each respective object in each of the plurality of images and the average temperature of the plurality of average temperatures associated with each of the plurality of images.

It should be appreciated that while the grid is shown as being an eight-by-eight grid, any other suitable grid size may be used, such as, for example, a six-by-six, a seven-by-seven, an eight-by-six, a nine-by-eight, a nine-by-nine, a ten-by-ten, and/or the like sized grid. Moreover, it should be appreciated that, while the grid is shown as having equally sized grid blocks, the grid may instead have varying size grid blocks, such as according to the relative sensitivity of the region within the field of view FOV1 of the temperature sensor(s) 110 as described in greater detail below.

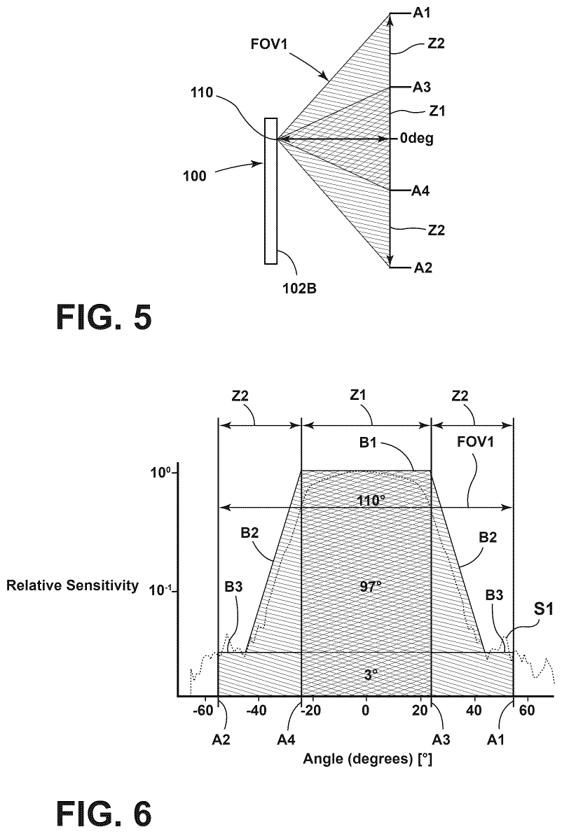

For each model or type of temperature sensor 110, the relative sensitivity of detection may vary across the field of view FOV1 of the temperature sensor 110. For instance, as shown with the side view of the mobile computing device 100 in FIG. 5, the field of view FOV1 of the temperature sensor 110 on the back side 102B of the mobile computing device 100 extends over an angular detection range defined between an upper angular limit A1 and a lower angular limit A2. The relative sensitivity SI of the particular temperature sensor 110 is plotted against the angle of detection for a particular type of the temperature sensor 110 in FIG. 6. Generally, the relative sensitivity for the particular type of the sensor 110 is greatest at the center (e.g., at 0°) of the field of view FOV1 and decreases toward the outside edges of the field of view FOV1. To account for the change in sensitivity, the field of view FOV1 of the temperature sensor(s) 110 may be divided into a plurality of different, discrete zones, where each zone has a different average sensitivity.

In the illustrated embodiment, for example, the angular detection range of the field of view FOV1 may extend across about 110°, where the upper limit A1 is about +55° and the lower limit A2 is about −55°. The field of view FOV1 of the temperature sensor(s) 110 is divided into a central zone Z1 and an outer zone Z2, where the relative sensitivity across the central zone Z1 is higher than the relative sensitivity across the outer zone Z2. The central zone Z1 is defined between an inner upper limit A3 and an inner lower limit A4, which are associated with where the relative sensitivity begins to decrease sharply (e.g., a slope of the sensitivity being above a threshold slope), where the inner upper limit A3 is about +25° and the inner lower limit A4 is about −25°. In some instances, the central zone Z1 accounts for the half-power region of the field of view FOV1 of the temperature sensor 110. The outer zone Z2 is defined between the central zone Z1 and the outer limits A1, A2 of the field of view FOV1 (e.g., the angular range between the upper limits A1, A3 and the angular range defined between the lower limits A2, A4).

The respective, approximate area of each zone bounded by the relative sensitivity taken with respect to the total area bounded by the relative sensitivity within the angular detection range may be used to determine a weight for the temperature measurements for the respective zone. For instance, from the illustrated example in FIG. 6 having the two zones Z1, Z2, the weight w₁ for each of the grid blocks within the central zone Z1 may be calculated as the area B1 of the central zone Z1 divided by the sum of the area B1 of the central zone Z1 and the areas of the sub-zones B2, B3 of the outer zone Z2, all divided by the number of grid blocks n_{z1} within the central zone Z1, shown in equation form as:

$${w}_{1} = \frac{( \frac{B 1}{B 1 + 2 * B 2 + 2 * B 3} )}{{n}_{z 1}} \qquad ( 1.1 )$$

$${w}_{1} = \frac{( \frac{( 50 * 1 )}{( 50 * 1 ) + ( 20 * 0.97 ) + 2 * ( 30 * 0.03 )} )}{16} = \frac{0.702}{16} = 0.0439 \qquad ( 1.2 )$$

Similarly, the weight w₂ for each of the grid blocks within the outer zone Z2 may be calculated as the areas B2, B3 of the central zone Z1 divided by the sum of the area B1 of the central zone Z1 and the areas of the sub-zones B2, B3 of the outer zone Z2, all divided by the number of grid blocks n_{z2} within the outer zone Z2, shown in equation form as:

$${w}_{2} = \frac{( \frac{2 * B 2 + 2 * B 3}{B 1 + 2 * B 2 + 2 * B 3} )}{{nz}_{2}} \qquad ( 2.1 )$$

$${w}_{2} = \frac{( \frac{( 20 * 0.97 ) + 2 * ( 30 * 0.03 )}{( 50 * 1 ) + ( 20 * 0.97 ) + 2 * ( 30 * 0.03 )} )}{48} = \frac{0.298}{48} = 0.0062 \qquad ( 2.2 )$$

It should be appreciated that any suitable temperature sensor having any suitable angular range for the field of view and a respective relative sensitivity may instead be used. It should further be appreciated that, in some instances, the number of zones may be predetermined and stored for the particular type and model of temperature sensor being used. For instance, while only two zones Z1, Z2 are described with reference to the example, any suitable number of zones may instead be defined, each having a respective, different weight. For example, in some implementations, only one zone, three zones, four zones, five zones, or any other suitable number of zones may instead be defined.

Referring back to FIGS. 4A-4C, the respective portion of the overlap region belonging to each object may further be determined based on the sensitivity of each zone that the respective portion encompasses. For instance, the computing system 200 is configured to determine, for each respective object of the at least one object in each of the plurality of images, the respective portion of the overlap region that includes the respective object by determining, for each respective object of the at least one object in each of the plurality of images, a respective portion of each zone of the plurality of zones (e.g., zones Z1, Z2) in the overlap region that includes the respective object. In some instances, the respective portion of each zone of the plurality of zones for one or more of the at least one object varies across each of the plurality of images.

For example, in FIG. 4A, the eight grid blocks (or 12.5%) of the overlap region associated with the coffee maker CM1 are all located in the outer zone Z2 and are thus weighted according to the weight w₂ for the outer zone Z2. Similarly, the four grid blocks (or 6.25%) of the overlap region associated with the microwave MW1 are all located in the outer zone Z2 and are thus weighted according to the weight w₂ for the outer zone Z2. Additionally, of the fifty-two grid blocks (or 81.25%) of the overlap region associated with the remaining ambient area AM1, sixteen of the grid blocks (or 25%) of the overlap region are in the central zone Z1 and weighted according to the weight w₁ for the central zone Z1, whereas the remaining 36 (or 56.25%) of the overlap region are located in the outer zone Z2 and weighted according to the weight w₂ for the outer zone Z2. In FIG. 4B, the eight grid blocks (or 12.5%) of the overlap region associated with the coffee maker CM1 are all in the central zone Z1 and weighted according to the weight w₁ for the central zone Z1, the ten grid blocks (or 15.63%) of the overlap region associated with the microwave MW1 are all located in the outer zone Z2 and weighted according to the weight w₂ for the outer zone Z2, and the forty-six grid blocks (or 71.87%) of the overlap region associated with the ambient area AM1 include eight grid blocks (or 12.5%) of the overlap region in the central zone Z1 and weighted according to the weight w₁ for the central zone Z1 and thirty-eight grid blocks (or 59.37%) of the overlap region in the outer zone Z2 and weighted according to the weight w₂ for the outer zone Z2. Additionally, in FIG. 4C, the eight grid blocks (or 12.5%) of the overlap region associated with the coffee maker CM1 are all located in the outer zone Z2 and weighted according to the weight w₂ for the outer zone Z2, the twelve grid blocks (or 18.75%) of the overlap region associated with the microwave MW1 are all located in the outer zone Z2 and weighted according to the weight w₂ for the outer zone Z2, and the forty-four grid blocks (or 68.75%) of the overlap region associated with the ambient area AM1 includes sixteen grid blocks (or 25%) of the overlap region in the central zone Z1 and weighted according to the weight w₁ for the central zone Z1 and twenty-eight grid blocks (or 43.75%) of the overlap region in the outer zone Z2 and weighted according to the weight w₂ for the outer zone Z2.

The computing system 200 is then configured to determine the temperature of at least one object (e.g., the desired object) within the overlap region based at least in part on the respective portion of each zone of the plurality of zones within the overlap region for each respective object in each of the plurality of images, the weight of each zone of the plurality of zones, and the average temperature associated with each of the plurality of images. For instance, in the example provided across FIGS. 4A-4C, the average temperature reading T_{A} associated with FIG. 4A, the average temperature reading T_{B} associated with FIG. 4B, and the average temperature reading T_{C} associated with FIG. 4C can each be set equal to the sum of the respective, weighted portions of the overlap detection area for the identified objects, as follows:

$${T}_{A} = ( 8 * 0.0062 * {t}_{CM 1} ) + ( 4 * 0.0062 * {t}_{MW 1} ) + ( 36 * 0.0062 * {t}_{AM 1} ) + ( 16 * 0.0439 * {t}_{AM 1} ) \qquad ( 3.1 )$$

$${T}_{B} = ( 8 * 0.0439 * {t}_{CM 1} ) + ( 10 * 0.0062 * {t}_{MW 1} ) + ( 38 * 0.0062 * {t}_{AM 1} ) + ( 8 * 0.0439 * {t}_{AM 1} ) \qquad ( 3.2 )$$

$${T}_{C} = ( 8 * 0.0062 * {t}_{CM 1} ) + ( 12 * 0.0062 * {t}_{MW 1} ) + ( 28 * 0.0062 * {t}_{AM 1} ) + ( 16 * 0.0439 * {t}_{AM 1} ) \qquad ( 3.3 )$$

Thereafter, the computing system 200 is configured to determine the temperature of at least the desired object by performing linear analysis on the respective portion of the overlap region for each respective object in each of the plurality of images and the average temperature associated with each of the plurality of images. For instance, if the coffee maker CM1 is the desired object, the equations may be rearranged to solve for at least the temperature t_{CM1} of the coffee maker CM1 in a known manner. For example, assuming the temperature T_{A} associated with FIG. 4A is equal to 70 degrees Fahrenheit, the average temperature reading T_{B} associated with FIG. 4B is equal to 82 degrees Fahrenheit, and the average temperature reading T_{C} associated with FIG. 4C is equal to 71 degrees Fahrenheit, the temperature TCM1 of the coffee maker CM1 may be determined to be approximately 104.95 degrees Fahrenheit, while the ambient temperature TAM1 of the surrounding area AM1 may be determined to be approximately 67.65 degrees Fahrenheit, and the temperature TMW1 of the microwave MW1 may be determined to be approximately 87.81 degrees Fahrenheit.

It should be appreciated that if more images by the imaging device(s) and corresponding temperature readings by the temperature sensor(s) 110 are available than the number of identified objects within the images, linear regression may be used to provide an even more accurate estimate of the temperatures of at least the desired object. It should also be appreciated that if the size of the grid blocks is varied according to the relative weight for each zone, instead of being equally sized across zones, the weight of the zones would not need to be accounted for in the linear equations above, just the number of grid blocks for each object.

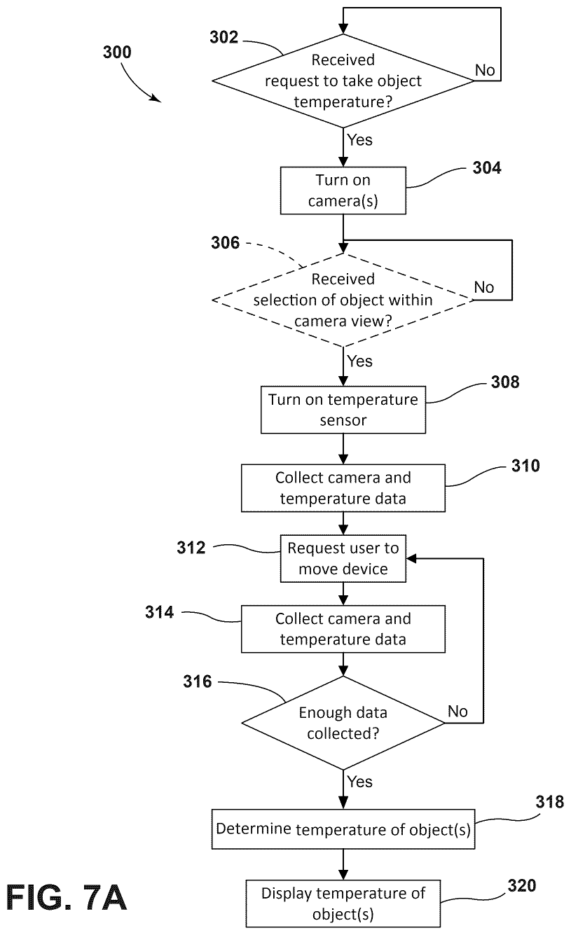

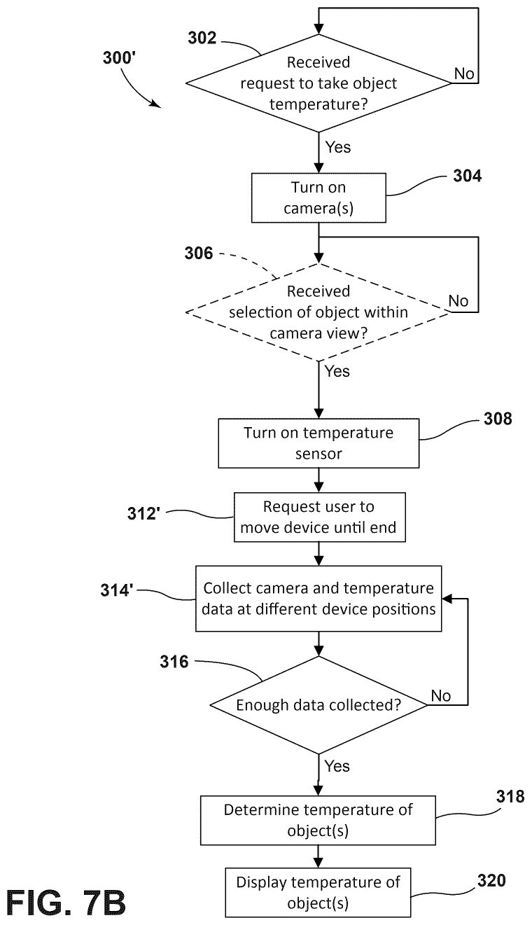

Referring now to FIGS. 7A and 7B, example flow diagrams for guiding a user to collect data for determining a temperature of an object using a mobile computing device are illustrated in accordance with aspects of the present subject matter. Although FIGS. 7A and 7B depict steps performed in a particular order for purposes of illustration and discussion, the methods of the present disclosure are not limited to the particularly illustrated order or arrangement. The various steps of FIGS. 7A and 7B can be omitted, rearranged, combined, and/or adapted in various ways without deviating from the scope of the present disclosure.

As shown in FIG. 7A, at step 302, the method 300 may include the computing system 200 determining whether a request has been received to take an object's temperature using the temperature sensor of the mobile computing device. For instance, in some embodiments, the initial request may be received when a user has requested launch of (e.g., tapped, used voice command, etc. to open or start) a temperature sensing application associated with the temperature sensor(s) 110 of the mobile computing device 100. In one or more embodiments, the initial request may be received when the camera application is open and running, and a temperature toggle within the camera application is switched on by the user. However, it should be appreciated that such examples are not exhaustive.

If an initial request to take an object's temperature has been received at step 302, then, at step 304, the method 300 may include turning on the camera(s), if not already on. For instance, when it is determined that a temperature sensing application, separate from a camera application, is opened, the computing system 200 may control the camera(s) to begin generating image data. Otherwise, if the camera(s) are already on, the computing system 200 may control the camera(s) to continue generating image data.

In some instances, the method 300 may optionally include receiving selection of an object within the camera field of view FOV2 at step 306. For instance, the computing system 200 may be configured to control an operation of a user interface (e.g., via the display assembly 104, speakers, and/or the like) to display or otherwise provide or describe at least a portion of the image data generated by the image device(s). A user may then be allowed to tap or otherwise select one or more objects within the camera field of view FOV2 for which the user would like a temperature reading. In some instances, the method 300 may include prompting a user to perform such selection. In some instances, the computing system 200 may use image recognition to identify potential objects which may be (or have been) selected by a user.

In some instances, in response to receiving the selection input, the method includes, at step 308, turning on the temperature sensor. For instance, when it is determined that a user would like the temperature of an object(s) to be provided, the computing system 200 may control an operation of the temperature sensor to begin generating the temperature data. However, in some instances, when step 306 is not used, the method 300 may proceed directly to step 308, such as simultaneously with step 304.

The method 300 may then collect image (e.g., camera) data and temperature data at step 310. For instance, as discussed above, the field of view FOV1 of the temperature sensor(s) 110 at least partially overlaps the field of view FOV2 of the image sensor(s) (e.g., camera(s) 108A, 108B, 108C), and an object within the field of view FOV2 of the image sensor(s) may be determined based in part on such overlapping image and temperature data. As such, at least one frame of overlapping image and temperature data is taken at step 310 for the purposes of temperature determination.

In some instances, after collecting at least one frame of image data and associated temperature data at step 310, the method 300 may include, at step 312, requesting the user to move the mobile computing device 100. For instance, as described above, multiple images taken with the imaging device(s) where the field of view FOV2 of the imaging device(s) each image only partially overlaps across the multiple images, and corresponding temperature data, are necessary to determine the temperature of a desired object(s). As such, the computing system 200 may control an operation of a user interface (e.g., the display assembly 104, speakers, and/or the like) to request an operator move the mobile computing device 100 to a different position. Particularly, in some instances, the computing system 200 may control the operation of the user interface (e.g., the display assembly 104, speakers, and/or the like) to indicate an amount of movement necessary for determining the temperature of the object(s). For example, the computing system 200 may control an operation of the operation of the display assembly 104 to show an arrow in a direction of movement that indicates a distance for the user to move and shrinks as the user moves the device in the direction of movement until the corresponding distance has been moved. In some instances, the distance that the user is prompted to move is based at least in part on the grid overlay (e.g., such that the desired object is in at least one new block of the grid). In some instances, the user is prompted to keep the mobile computing device 100 in the same plane at a generally constant distance from the desired object(s), but to move the mobile computing device 100 left and right, up and down, and/or the like within the plane. In one or more instances, the computing system 200 may instruct the user to keep the desired object(s) at least partially within the field of view FOV1 of the temperature sensor(s) 110. In some instances, image data, motion data (e.g., from an IMU), and/or the like may be used to confirm the movement of the mobile computing device 100.

Once the mobile computing device 100 has been moved, the method 300 may include, at step 314 collecting further camera and temperature data such as performed at step 312. It should be appreciated that the step 310 may be omitted, such that the user is requested to move the mobile computing device at step 312 before data is collected at 314 for the purposes of temperature determination.

Thereafter, the method 300 may determine if enough data is collected at step 316 to determine the temperature of the desired object(s). For instance, as indicated above, the computing system 200 may determine the minimum number of images and corresponding temperatures needed to accurately determine the temperature(s) of the desired object(s). The computing system 200 may be configured to control the operation of the user interface to request an operator move the mobile device based on a number of the at least one other object within the field of view of the image device(s). For instance, as a general rule, the minimum number is at least two. In some instances, the minimum number is equal to the total number of objects identified within the initial image (e.g., three sets of data for three objects identified). If at least the minimum number of images and corresponding temperature data has not been collected at step 316, then the method 300 may return to step 312. As such, the user may be asked iteratively to move the mobile computing device 100, in other words, may be requested to perform one movement at a time.

However, if at least the minimum number of images and corresponding temperature data has been collected at step 316, then the method 300 may proceed to step 318, where the temperature of the desired or target object(s) is determined. For instance, as discussed above, the computing system 200 may determine, for each respective object within the overlap region between the image and corresponding field of view of the temperature data, a respective portion of the overlap region (particularly, if applicable, the respective portion of each sensitivity zone) that includes the respective object. The computing system 200 may then determine the temperature of the desired object(s) based at least in part on the respective portion of the overlap region for each respective object in each of the plurality of images (if applicable, the weight of the sensitivity zones), and the average temperature of the plurality of average temperatures associated with each of the plurality of images. The computing system 200 may then determine the temperature of the desired object(s) by performing linear analysis (e.g., a series of linear equations, linear regression, and/or the like) on the respective portion of the overlap region for each respective object in each of the plurality of images and the average temperature associated with each of the plurality of images.

In some instances, the method 300 may determine the confidence of the temperature determined at step 318. For instance, after determining the temperature at step 318, the method 300 may include collecting further camera and temperature data according to steps 312 and 314, before determining the temperature again according to step 318. If the second determination of the temperature has changed from the initial determination of the temperature by more than a threshold amount, the computing system 200 may return to collecting further data until the temperature determined has settled (e.g., is within a threshold amount from previous temperature determinations).

At step 320, the method 300 may include controlling the operation of the user interface to provide the temperature of the desired object. For instance, the computing system 200 may control the operation of the user interface (e.g., the display assembly 104, speakers, and/or the like) to indicate the temperature of the desired object(s), such as the object(s) selected at step 306 and/or each object detectable within the overlap region across the plurality of images.

The method 300′ of FIG. 7B is substantially the same as the method 300 of FIG. 7A, with substantially identical steps being denoted with the same reference numbers, except that the user is requested at step 312′ to keep moving the mobile computing device 100 until enough data is determined to be collected at step 316 and/or the temperature of the desired object(s) is provided at step 320, and image and temperature data is collected at step 314′ at different positions of the mobile computing device 100 during such movement in step 312′. The user may still be guided in method 300′ as to the speed and/or amount of distance to move the mobile device 100 during the data collection at step 314, but is not iteratively asked, as in method 300.

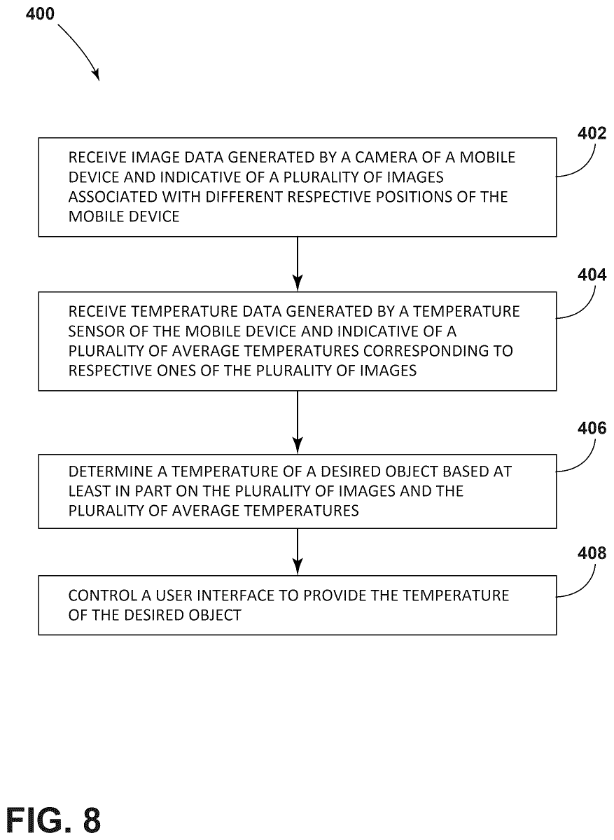

Referring now to FIG. 8, an example method 400 for determining a temperature of an object using a mobile computing device in accordance with aspects of the present subject matter. Although FIG. 8 depicts steps performed in a particular order for purposes of illustration and discussion, the methods of the present disclosure are not limited to the particularly illustrated order or arrangement. The various steps of the method 400 can be omitted, rearranged, combined, and/or adapted in various ways without deviating from the scope of the present disclosure.

At (402), the method 400 may include receiving image data generated by a camera of a mobile device and indicative of a plurality of images associated with different respective positions of the mobile device. For instance, as described above, the computing system 200 may receive image data generated by a camera (e.g., camera 108A) of the mobile computing device 100, where the camera has a field of view FOV2, and the image data is indicative of a plurality of images, where each of the plurality of images is associated with a different respective position of the mobile computing device 100 such that the field of view FOV2 in each of the plurality of images only partially spatially overlaps the field of view FOV2 in each other image of the plurality of images.

Further, at (404), the method 400 may include receiving temperature data generated by a temperature sensor of the mobile device and indicative of a plurality of average temperatures corresponding to respective ones of the plurality of images. For example, as discussed above, the computing system 200 may receive temperature data generated by a temperature sensor of the mobile device, the temperature sensor having a second field of view, the first field of view and the second field of view at least partially overlapping, the temperature data being indicative of a plurality of average temperatures, each of the plurality of average temperatures corresponding to a respective one of the plurality of images.

Moreover, at (406), the method 400 may include determining a temperature of a desired object based at least in part on the plurality of images and the plurality of average temperatures. For instance, as discussed above, the computing system 200 may determine a temperature of a desired object based at least in part on the plurality of images and the plurality of average temperatures, the desired object being at least partially within both the first field of view and the second field of view during generation of the image data and the temperature data.

Additionally, at (408), the method 400 may include controlling a user interface to provide the temperature of the desired object. For example, as described above, the computing system 200 may control a user interface (e.g., the display assembly 104, speakers, and/or the like) to provide the temperature of at least the desired object.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A system for determining a temperature of an object, the system comprising:
a mobile device, comprising:
a camera configured to generate image data across a first field of view; and
a temperature sensor configured to generate temperature data across a second field of view, the first field of view and the second field of view at least partially overlapping; and
a computing system configured to:
receive the image data generated by the camera, the image data being indicative of a plurality of images, each of the plurality of images being associated with a different respective position of the mobile device such that the first field of view in each of the plurality of images only partially spatially overlaps the first field of view in each other image of the plurality of images;
receive the temperature data generated by the temperature sensor, the temperature data being indicative of a plurality of average temperatures, each of the plurality of average temperatures corresponding to a respective one of the plurality of images; and
determine, based at least in part on the plurality of images and the plurality of average temperatures, a temperature of a desired object, the desired object being at least partially within both the first field of view and the second field of view during generation of the image data and the temperature data.

2. The system of claim 1, wherein the desired object extends across only part of the second field of view during generation of the temperature data.

3. The system of claim 1, wherein the computing system is further configured to:
determine, for each of the plurality of images, an overlap region where the second field of view overlaps the first field of view;
identify, for each of the plurality of images, at least one object within the overlap region, the at least one object including the desired object; and
determine, for each respective object of the at least one object in each of the plurality of images, a respective portion of the overlap region that includes the respective object,
wherein the computing system is configured to determine the temperature of the desired object based at least in part on the respective portion of the overlap region for each respective object in each of the plurality of images and the average temperature of the plurality of average temperatures associated with each of the plurality of images.

4. The system of claim 3, wherein the computing system is further configured to divide the overlap region for each of the plurality of images into a plurality of zones, each zone of the plurality of zones being associated with a different weight,
wherein the computing system is configured to determine, for each respective object of the at least one object in each of the plurality of images, the respective portion of the overlap region that includes the respective object by determining, for each respective object of the at least one object in each of the plurality of images, a respective portion of each zone of the plurality of zones in the overlap region that includes the respective object,
wherein the computing system is configured to determine the temperature of the desired object based at least in part on the respective portion of each zone of the plurality of zones for each respective object of the at least one object in each of the plurality of images, the weight of each zone of the plurality of zones, and the average temperature associated with each of the plurality of images.

5. The system of claim 4, wherein the respective portion of each zone of the plurality of zones for one or more of the at least one object varies across each of the plurality of images.

6. The system of claim 3, wherein the computing system is configured to determine the temperature of the desired object by performing linear analysis on the respective portion of the overlap region for each respective object in each of the plurality of images and the average temperature associated with each of the plurality of images.

7. The system of claim 1, wherein the computing system is further configured to:
receive an initial request via a user interface indicative of a request to begin using the temperature sensor of the mobile device; and
control the camera to begin generating the image data in response to receiving the initial request.

8. The system of claim 1, wherein the computing system is further configured to:
control an operation of a user interface to display at least a portion of the image data generated by the camera;
receive a selection input via the user interface indicative of a selection of the desired object from the at least the portion of the image data; and
control the operation of the user interface to provide the temperature of the desired object.

9. The system of claim 8, wherein the computing system is further configured to:
identify at least one other object within the image data aside from the desired object; and
control the operation of the user interface to request an operator move the mobile device based on a number of the at least one other object.

10. The system of claim 8, wherein the computing system is further configured to control the temperature sensor to begin generating the temperature data in response to receiving the selection input.

11. The system of claim 1, wherein the temperature sensor is an infrared sensor.

12. The system of claim 11, wherein the infrared sensor is a single-pixel infrared sensor.

13. A method for determining a temperature of an object, the method comprising:
receiving, with a computing system, image data generated by a camera of a mobile device, the camera having a first field of view, the image data being indicative of a plurality of images, each of the plurality of images being associated with a different respective position of the mobile device such that the first field of view in each of the plurality of images only partially spatially overlaps the first field of view in each other image of the plurality of images;
receiving, with the computing system, temperature data generated by a temperature sensor of the mobile device, the temperature sensor having a second field of view, the first field of view and the second field of view at least partially overlapping, the temperature data being indicative of a plurality of average temperatures, each of the plurality of average temperatures corresponding to a respective one of the plurality of images;
determining, with the computing system, a temperature of a desired object based at least in part on the plurality of images and the plurality of average temperatures, the desired object being at least partially within both the first field of view and the second field of view during generation of the image data and the temperature data; and
controlling, with the computing system, a user interface to provide the temperature of the desired object.

14. The method of claim 13, further comprising:
determining, with the computing system for each of the plurality of images, an overlap region where the second field of view overlaps the first field of view;
identifying, with the computing system for each of the plurality of images, at least one object within the overlap region, the at least one object including the desired object; and
determining, with the computing system, for each respective object of the at least one object in each of the plurality of images, a respective portion of the overlap region that includes the respective object,
wherein determining, with the computing system, the temperature of the desired object comprises determining the temperature of the desired object based at least in part on the respective portion of the overlap region for each respective object in each of the plurality of images and the average temperature of the plurality of average temperatures associated with each of the plurality of images.

15. The method of claim 14, further comprising dividing, with the computing system, the overlap region for each of the plurality of images into a plurality of zones, each zone of the plurality of zones being associated with a different weight,
wherein determining, with the computing system, for each respective object of the at least one object in each of the plurality of images, the respective portion of the overlap region that includes the respective object comprises determining, for each respective object of the at least one object in each of the plurality of images, a respective portion of each zone of the plurality of zones in the overlap region that includes the respective object,
wherein determining, with the computing system, the temperature of the desired object comprises determining the temperature of the desired object based at least in part on the respective portion of each zone of the plurality of zones for each respective object of the at least one object in each of the plurality of images, the weight of each zone of the plurality of zones, and the average temperature associated with each of the plurality of images.

16. The method of claim 14, wherein determining, with the computing system, the temperature of the desired object comprises determining the temperature of the desired object by performing linear analysis on the respective portion of the overlap region for each respective object in each of the plurality of images and the average temperature associated with each of the plurality of images.

17. The method of claim 13, further comprising:
receiving, with the computing system, an initial request via a user interface indicative of a request to begin using the temperature sensor of the mobile device; and
controlling, with the computing system, the camera to begin generating the image data in response to receiving the initial request.

18. The method of claim 13, further comprising:
controlling, with the computing system, an operation of a user interface to display at least a portion of the image data generated by the camera;
receiving, with the computing system, a selection input via the user interface indicative of a selection of the desired object from the at least the portion of the image data; and
controlling, with the computing system, the operation of the user interface to provide the temperature of the desired object.

19. The method of claim 18, further comprising:
identifying, with the computing system, at least one other object within the image data aside from the desired object; and
controlling, with the computing system, the operation of the user interface to request an operator move the mobile device based on a number of the at least one other object.

20. The method of claim 18, further comprising:
controlling, with the computing system, the temperature sensor to begin generating the temperature data in response to receiving the selection input.
